(19) United States
(12) Patent Application Publication
(10) Pub. No.: US 2015/0206125 A1
(43) Pub. Date: Jul. 23, 2015

(54) METHOD, SYSTEM, AND COMPUTER-READABLE MEDIUM FOR PROVIDING A NEAR FIELD SECURE ELECTRONIC TOKEN TRANSACTION

(71) Applicants: Deepak Hoshing, Bangalore (IN); Manoj Kumar Agarwal, Sambalpur (IN); Debasis Pati, Sambalpur (IN); Krishna Kumar, Bhubaneswar (IN)

(72) Inventors: Deepak Hoshing, Bangalore (IN); Manoj Kumar Agarwal, Sambalpur (IN); Debasis Pati, Sambalpur (IN); Krishna Kumar, Bhubaneswar (IN)

(73) Assignee: Infosys Limited, Bangalore (IN)

(21) Appl. No.: 14/416,038

(22) PCT Filed: Jul. 24, 2012
(86) PCT No.: PCT/IN2012/000516

§ 371 Date: Jan. 20, 2015

(51) Int. Cl. G06Q 20/32; G06Q 20/38

(52) U.S. Cl. CPC G06Q 20/3226; G06Q 20/3278; G06Q 20/3829

(57) ABSTRACT

The present invention relates to a computer-implemented method, system and computer readable medium method executed by one or more computing devices for providing a near field secure electronic token transaction. The method comprises the steps of generating at least one packet data structure defined as a coin by at least one generator, storing the at least one coin in at least one mobile vault, controlling the at least one coin through a coin distribution authority and transferring the coin to at least one consumer.

### FIELD OF THE INVENTION

The present invention relates to the field of Near Field Communication (NFC). In particular, the present invention provides a computer-implemented method, system and computer readable medium for providing a near field secure electronic token transaction.

### BACKGROUND OF THE INVENTION

The technical journals and papers on peer to peer communication or a hybrid communication between peers and servers have evoked ideas generically around using Bluetooth or infrared for establishing a personal area network within a person's immediate surroundings. A technology on NFC tag and RFID technology are similar in a very limited way. QR codes are also information bundles with a specific purpose of locating a document.

There are no commercially available means to distribute NFC tags in a coherent and business relevant manner over the wire. RFIDs are available from commercial vendors but they are in physical form and need specialized devices to process them.

A combination of peer to peer technology enabling exchange of pre-coined tokens in an accountable and traceable manner is not available. NFC Tags and RFIDs are physical data holders. In the existing technology, no soft tokens are available which can be generated independently and distributed to participating vault holders as a means of traceable value stores.

Thus, there is a need to overcome the problems of the existing technologies. Therefore, the present inventors have developed a computer-implemented method, system and computer readable medium for providing a near field secure electronic token transaction which would use a mobile phone device as a means to store semantically relevant information packets wherein the information packet or coin is unique and authoritatively defined for the holder and signifies commercial or social value for owner of the mobile device.

### SUMMARY OF THE INVENTION

According to one aspect of the invention there is provided a computer implemented method executed by one or more computing devices for providing a near field secure electronic token transaction. The method comprises the steps of generating at least one packet data structure, defined as a coin, by at least one generator, storing the at least one coin in at least one mobile vault, controlling the at least one coin through a coin distribution authority and transferring the coin to at least one consumer.

According to another aspect of the invention there is provided a machine comprising a processor and a processor readable memory which contains data representing a packet data structure. The packet data structure (coin) comprises a coin id field of predetermined size comprising alphanumeric characters, a coin value field comprising a plurality of attributes, a coin content field, a coin camouflage field comprising a plurality elements placed in a contiguous area of memory, an attribute key field comprising a predetermined size of hexadecimal characters, a URL collection field, an issue date field, recording a date of creation of the coin, an issuer field, wherein the issuer is a mint or a central agency, an owner id field, wherein said owner id comprises a vault id, an owner signature field, wherein said owner signature comprises a coin signature created by said owner's certificate, at least two watermarks fields such as watermark1 and watermark2 and a coin lock field;

According to another aspect of the invention there is provided a system for providing a near field secure electronic token transaction. The system comprises a memory and a processor operatively coupled to the memory, the processor configured to perform the steps of generating at least one packet data structure, defined as a coin, by at least one generator, storing the at least one coin in at least one mobile vault, controlling the at least one coin through a coin distribution authority and transferring the coin to at least one consumer.

According to another aspect of the invention there is provided a computer-readable code stored on a non-transitory computer-readable medium that, when executed by a computing device, performs a method for providing a near field secure electronic token transaction. The method comprises the steps of generating at least one packet data structure, defined as a coin, by at least one generator, storing the at least one coin in at least one mobile vault, controlling the at least one coin through a coin distribution authority and transferring the coin to at least one consumer.

### BRIEF DESCRIPTION OF THE DRAWINGS

Features, aspects, and advantages of the present invention will be better understood when the following detailed description is read with reference to the accompanying drawings in which like characters represent like parts throughout the drawings, wherein:

FIG. 1 shows a coin data structure;

FIG. 2 shows a vault design on a Bluetooth enabled device;

FIG. 3 shows a vault registration and coin disbursement to vault;

FIGS. 4A and 4B show a flowchart depicting a method of coin disbursement sequence for vault fill up;

FIG. 5 shows a flowchart depicting a method of coin dispensation to vault from mint;

FIG. 6 shows a flowchart depicting a method of coin transfer to consumer; and

FIG. 7 shows a generalized computer network arrangement, in one embodiment of the present technique.

### DETAILED DESCRIPTION OF THE INVENTION

While system and method are described herein by way of example and embodiments, those skilled in the art recognize that system and method for providing a near field secure electronic token transaction. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As a preliminary matter, the definition of the term “or” for the purpose of the following discussion and the appended claims is intended to be an inclusive “or” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A” by itself, “B” by itself and any combination thereof, such as “AB” and/or “BA.” It is worth noting that the present discussion relates to exemplary embodiments, and the appended claims should not be limited to the embodiments discussed herein.

Disclosed embodiments provide a computer-implemented method, system and computer readable medium for providing a near field secure electronic token transaction. The invention describes a mobile device vault for safe keeping electronic tokens which are bearers of promised values and are uniquely identifiable over the value domain. It also enlists the strategy, algorithms, protocols and software components conceptualized and implemented for creating a software system and product for achieving the mobile device vault.

The invention is an attempt to provide regulatory authorities, a mechanism to circulate unique electronic identifiers i.e. ‘Coins’ to participating members, who can then use the identifiers in the manner stipulated by the authority.

For example if the authority specifies that the a coin will uniquely identify an individual, then the coin will carry relevant information about the person owning it and will reside in the mobile vault in such a manner that, the person can present the coin to any other member who needs an identity proof from the holder of the coin. It will be possible to verify the coin's relevance and authenticity from the authority database as to being assigned to the holder.

As an alternative, the coins can represent a promised value to the holder and the holder can then exchange or redeem it with other members for receiving the benefits of the promised value.

A coins compatibility with the vault is declared and defined by the regulatory authority. Vaults can be generically available for various coin categories in circulation in the society. Regulatory authorities can envision the purpose of the coin and declare a list of ‘adaptable’ vaults so that members participating under the authority can ‘procure’ the vault for holding the relevant coins. However, for holding a specific category of one or more coins, the vault needs to latch itself with the regulatory authority issuing such coins. The latching process may vary based on domain of usage, but it is guaranteed that the specified vault is uniquely identifying the holder of such vault. So when a vault holds one or more coins it creates a virtual contract of bonding between the vault holder and the coin circulator in such a manner that the data contained in the coin stands in for a promise or a contract.

The invention mainly comprises of three elements such as Coins, mobile vaults and Coin Community Control Center.

Coins: This can be defined as a bundle of semantically relevant data packet, secured by cryptography and camouflaged by watermarks and bearing unique identity assigned through a central agency.

Mobile vaults: These are mobile applications which can be installed in Bluetooth enabled devices or devices with near field communication support.

Coin Community Control Center or ‘Mint’ for producing the coins, distributing the same to rightful owners and providing verification service for coin holders to ascertain genuineness and ownership of the coins.

A business or social eco system can be formulated using the above mentioned components. A central authority, hereafter called regulator, can assume the responsibility of installing the systems for ‘minting’, distributing and book keeping accountability of the coins distributed amongst members of a community, wherein members can be categorized as coin consumers, coin distributors, coin holders and accountants. A coin holder and a coin consumer can assume both responsibilities interchangeably.

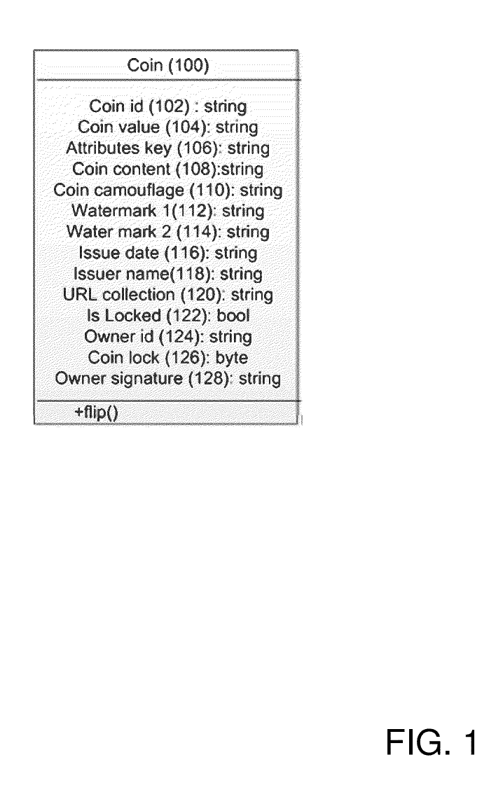

FIG. 1 shows a coin data structure (100) and is represented as an object in the following manner. It has two faces. Face one represents a watermark and a set of attributes denoting specific content the coin may signify. The watermark on face one is permanent and fixed at the time of minting. The opposite face has a watermark representing a contract between two parties and is embossed on the coin at the time of a transfer or allocation from one party to other. As the coin traverses between community members as transactions are effected, the watermarks keep changing to represent the contract between the parties involved. Face twois a lock state denoting ownership of the coin. A coin can be flipped to Face one (open state) and face two (locked state).

Face one is the open state of the coin. In this state the coin can be transferred to another holder. The elements in the coin are as follows:

Coin id (102): A ten character alphanumeric sequence comprising of ASCII character set in the range of English characters and digits.

Coin Value (104): This is a digest of attributes chosen relevant to the domain of usage of the coin. Each attribute have fixed number of characters including spaces.

Attributes Key (106): The attribute key is specified as 2*N hexadecimal character sequence representing ‘n’ attributes and each hexadecimal pair representing the length of character sequence in each attribute. The decimal equivalent of hexadecimal pair is used to arrive at the length.

Coin Content (108): All attributes extent in terms of specified length. The entire content buffer is digested using the mint's private key. The digest is assigned to the coin value.

Coin camouflage (110): An array of X random numbers having each of 16 characters.

Watermark1 (112): X signatures of the corresponding random numbers in the camouflage.

URL Collection (120): X URLs each pointing to the site which generated the respective random number in the camouflage. The URLs will be used to download the certificates of the sites participating in the random number generation.

Issue Date (116): date on which the coin is created

Issuer name (118): The ‘mint’ name or CA circulating the coin.

Owner Id (124): The vault id where the coin lies.

Owner's Signature (128): The coin signature created by the owner's certificate.

Watermark2 (114): The watermark1 and the array of camouflage is signed using the private key of the issuer. It is then encrypted using the public key of a recipient. When the coin is in mint's possession the encryption is done by the public key of the mint. When it is transferred to a holder's vault it is encrypted using the vault owner's public key.

Face two is the locked state of the coin. It can only be in possession of its owner in this state.

Coin Lock (126): The encrypted coin (all fields). Only the owner can decrypt it.

The strength of the cryptography camouflage for the coin will depend upon the number of random numbers used in the mint which created it.

When a coin is flipped, all fields will get masked and coin Lock (122) will be set. The coin can be flipped again by the same holder to reset the fields and clear the coin Lock.

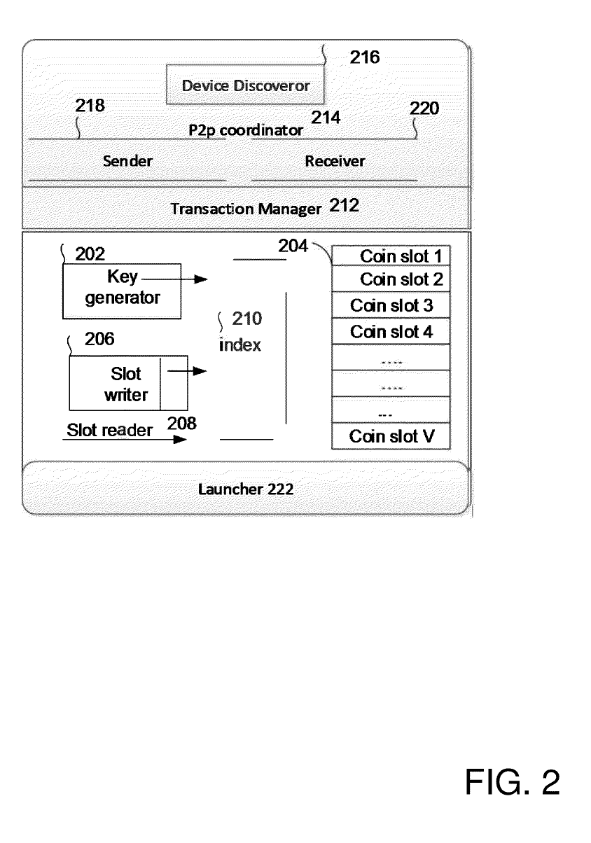

FIG. 2 shows a vault design on a Bluetooth enabled device. A mobile device application which encapsulates a storage area of fixed contiguous length. The store area is split into fixed size slots each capable of holding a coin. Each slot may be empty, filled or blocked. An empty slot can receive a coin from a producer or another holder. A blocked slot is one which had a coin previously but has transferred a coin to another holder or a consumer. The slot now holds details of acknowledgement from the receiver, and is in encrypted format which can only be unlocked by the CA. A filled slot contains a valid coin and is ready for participating in its usage as per the domain implementation.

The Vault components are as follows:

An embedded key generator (202) with one way key generations. A generated key is never remembered. The key is used to encrypt a slot.

Slot Set (204): The storage area is divided into equal areas each area indexed by a slot identifier.

Slot writer (206): A utility which writes one or more modified slots into the storage area. The slot writer is aware of coin transfers either into or out of the vault. When instructed to write, the slot writer generates as many keys as modified slots and uses them to encrypt the slot content in memory and then persist into the slot storage area. The slot write updates an index area with a key counter. The slot can now be decrypted only when the correct key is made available to it. The key counters are used to interact with the CA to get the actual key for slot decryption when the slot reader is invoked.

A slot reader (208) has several overloaded read operations. When the slot detects the vault to be online in GPRS mode it can fetch the slot keys from the server which might, need be decrypted for a transaction. For operations in offline mode the reader will cause an SMS to be dispatched to the CA, which will then send across the slot key. The reader may refer to a slot index for identifying the slots to read.

Vault Index (210): Consists of Slot identifier, Last Write Date, Slot crypto sequence, Slot Status and Additional Information.

Slot identifier: A three digit running serial number.

Last Write Date: When the slot was written to.

Slot crypto sequence: The key sequence number used to encrypt the slot.

Slot Status: Empty/Open/Closed. Empty slots have no data. Closed slots are sealed and should not be read. A closed slot has additional information set.

Additional Information: This contains crypto sequence counter of receiver slot, vault unique identifier of the receiver vault and other log details of a transaction.

Vault launcher (222): It verifies application checksum, compares Bluetooth mac address etched into vault with the real Bluetooth mac address and verifies the pin entered by the user. The checksum of the application is calculated based on input stream of a set number of classes which are deemed to be unalterable with respect to application functioning.

Transaction Manager (212): This is the controller of the coin based transaction. This may perform the data changes on the vault when a coin exchange is initiated. The Transaction manager ensures consistency and integrity of the data allowing for a complete commitment of the transaction or rollback into original state. Device failure, connection failure as well as intentional abortion of a transaction may all result in in a decision by the TM to either carry forward the pending transaction to logical conclusion on mutual consent or restore the vault state to original state, and reversing all effects of the transaction steps completed so far.

P2P Coordinator (214): It manages a set of protocol handlers based on device capabilities for forming a P2P network with a near field device.

Device Discoverer (216): It generates the relevant wireless signal for pairing up with a consumer device. The handshake and authentication is performed by this component.

Sender (218): Searches for nearby devices and pair with a device based on user acceptance and as part of an intention to perform a send transaction.

Receiver (220): Looks for connect request from nearby devices and accepts a connection based on mutual acceptance.

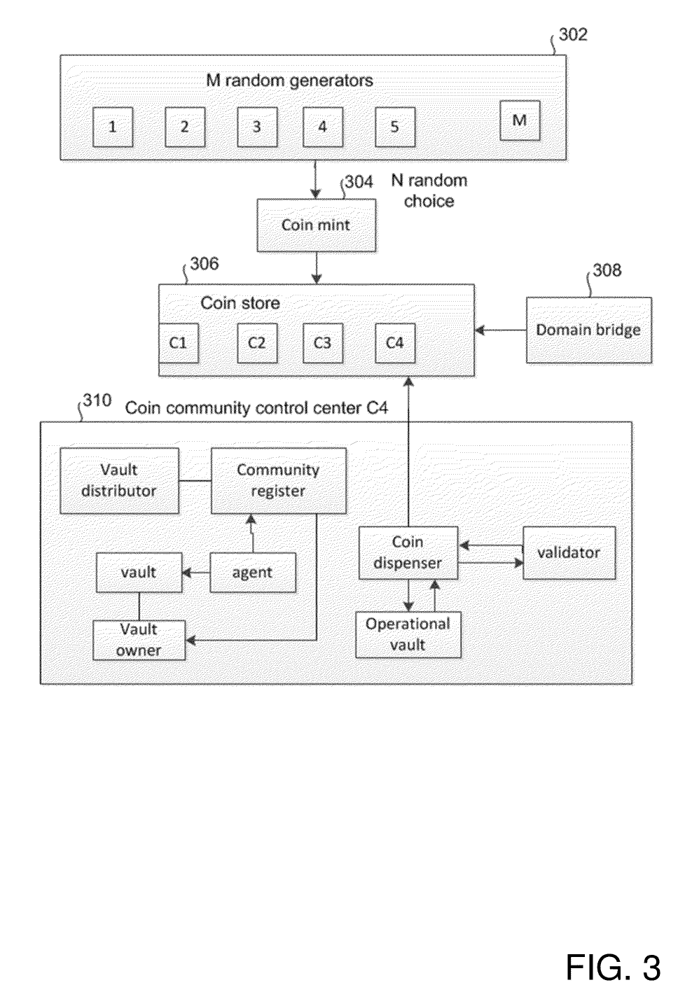

FIG. 3 shows a vault registration and coin disbursement to vault. The Coin Distribution Authority (CDA) maintains a ‘mint’ (304), which creates a coin when asked. The ‘mint’ is linked to a Coin Community Control Center, referred to as C4 (310) henceforth. The C4 (310) provisions for the computer systems to assign and track vault holders, distribute coins, track ownership of the same and provides for verification services for a coin based transaction and authenticity of the same.

The ‘mint’ comprises of ‘M’ random number generator functions (302) distributed across multiple servers. The mint can choose any ‘N’ function generators and request for a random number from each. Each such number is signed by the function generator's certificate using its private key. The function generator uses a new certificate after expiry of a specified period. However, the C4 (310) keeps the certificate live for verification of coins distributed.

The ‘mint’ creates coins in bulk and keeps the same in secured data storage systems (306). Several storage denominations are maintained for various content categories supported in the C4 (310).

The C4 (310) maintains a public service from where the vault application can be downloaded for all such mobility devices which can support the installation of the vault application. Vault applications are released on a periodic basis based on community advancements. A vault holder can download the installable from this service. The vault at this stage is unregistered and cannot hold coins.

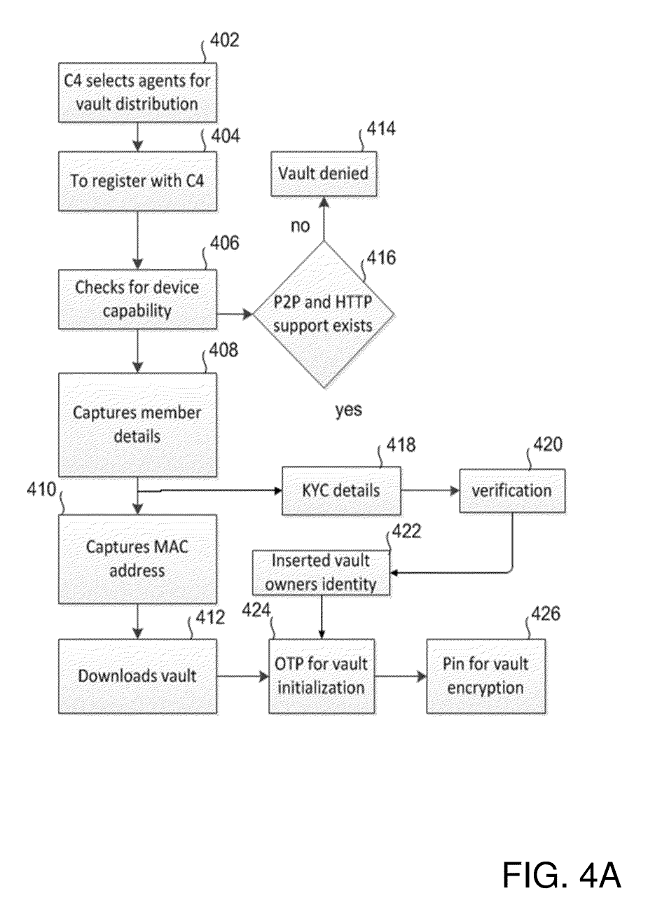

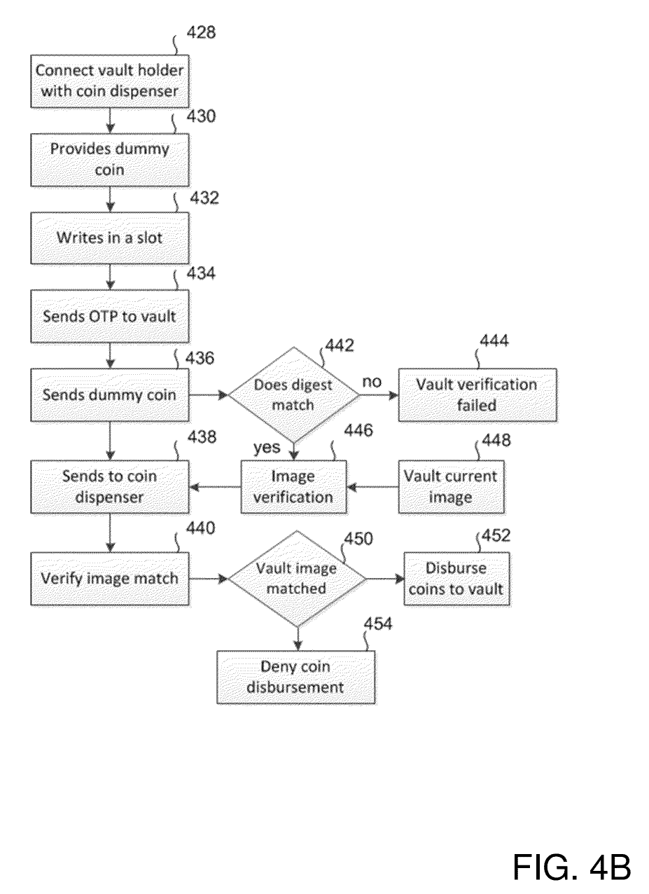

FIGS. 4A and 4B show a flowchart depicting a method of coin disbursement sequence for vault fill up. The C4 have contact centers or appoint agents (402) for member registration. A vault holder approaches an agent to install and initialize the vault (404) in one of the devices which the member may so wish. It is expected that the device may support Bluetooth communication capabilities. The vault version may support protocols apart from Bluetooth, such as infrared or any other technology which may emerge in future to support a device to device connectivity and which uniquely identifies a protocol adapter in that device (406). The adapter address which is unique across the universe is revealed by the device owner. The mac address (410) is recorded in an enrollment form either electronically or in physical form. The application download process takes as input the vault holder's name, device id, mac address, date of initialization and a communication address (408). The communication address can be mobile number, email id or a physical address. The download site records these inputs as well as uses them to generate a user specific application for the member. This is then downloaded and installed into the device.

On receipt of the enrollment form a KYC check (418) is performed and C4 creates a membership for the vault holder (420). At this stage the vault is empty. In order to insert coins in the vault, the vault member must perform a coin download. The coins download is authorized by the C4 based on the specific operational considerations associated with coin community (422). In case it is to be treated as electronic money, the relevant money accounting is done by the C4. In case it acts like an identity provider, the C4 will generate a coin by linking the content with an HR system providing an employee number to the coin. The C4 enlists the relevant process for member enrollment and coin disbursement to the vault holder. When the C4 sees that appropriate KYC checks and authorization has been received as part of the member enrollment process, the pin used for encrypting relevant vault portions is dispatched to the member. The member can then use it to make the vault make an attempt to connect to the C4. The pin was used at the time of creating the user specific installable and it has encrypted the vault reader, writer and other secured components such that the vault can be initialized for connection only on input of the pin. The holder is forced to provide a personalized pin for initialization (424). At that moment the new pin is used to encrypt the application's secured areas (426).

On initialization, the vault connects to the C4's coin dispenser (428). An identity assertion protocol is used in the manner described below to allow the download of coin. The vault establishes an HTTPS connection (416) with the dispenser. The coin dispenser provides a dummy coin (430) to the vault. The vault writes this into a slot (432). The coin dispenser then provides an OTP to the vault (434). The vault must read the coin (436) and reveal the checksum of the coin back to the dispenser (438). The dispenser then provides a list of objects for which the vault must calculate a checksum and reveal to the dispenser. On successful match (442) at the server, the vault can now start prompting the holder for coins download related inputs (446). These inputs are specific to the domain in which the coin operates for this community. The coins are downloaded to the vault (452) based on these attributes. The vault is now ready for operation.

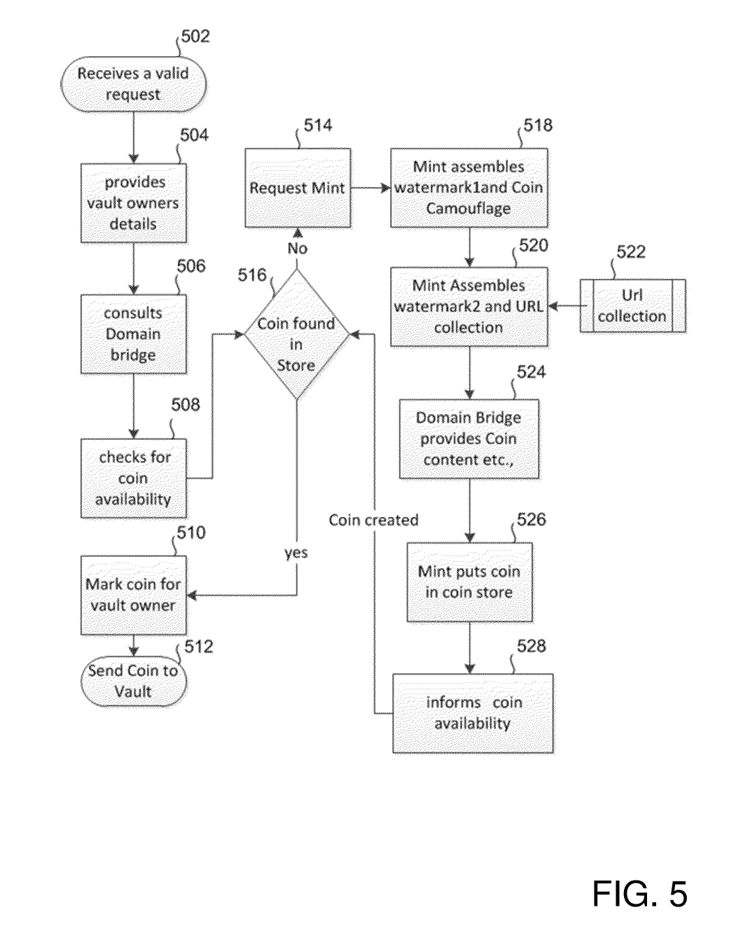

FIG. 5 shows a flowchart depicting a method of coin dispensation to vault from mint. The coin dispenser in C4 receives a valid request for coin disbursement (502). The coin dispenser provides vault owners details to coin store (504). Coin store consults Domain Bridge for unique identifier and authorization of coin dissemination to vault (506). The coin store checks for coin availability (508). If coin is found in the store then mark coin for vault owner in community register and flip it for vault holder ownership (510) and then send coin to vault (512). If coin is not found in store then request mint for coin creation (514). Mint assembles watermark1 and coin camouflage (518). Further provided URL collection (522) to Mint. Then, further, mint assembles watermark2 and URL collection (520). The domain bridge provides coin content, issue date, issuer stamp, coin value, coin id and attributes key (524). Mint puts coin in coin store (526). Coin store informs coins dispensers of coin availability (528). Since, coin is found in store and then mark coin for vault owner in community register and flip it for vault holder ownership (510) and then sends coin to vault (512).

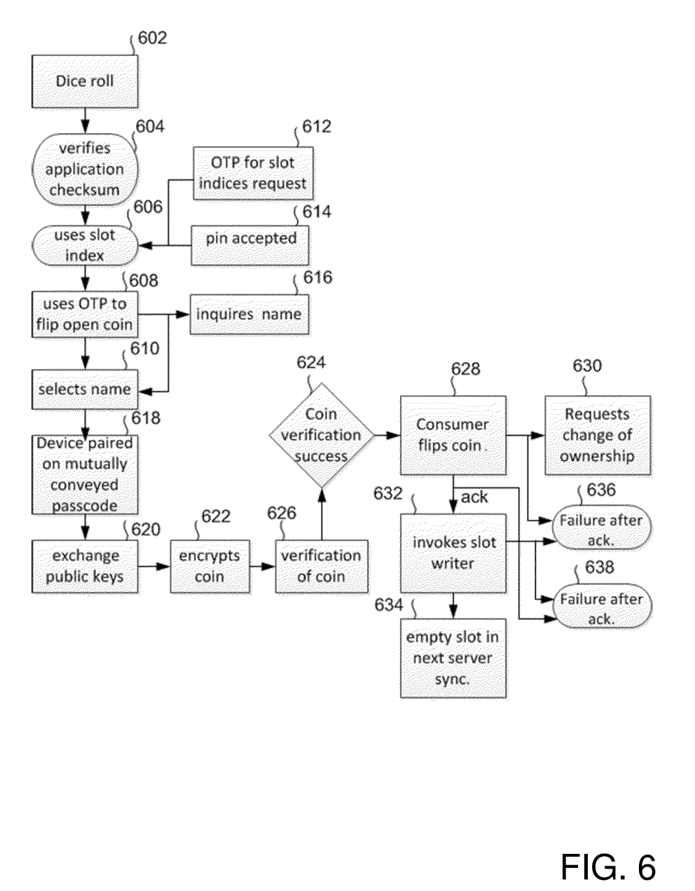

FIG. 6 shows a flowchart depicting a method of coin transfer to a consumer. The dice roll (602) is used to arrive at the next coordinate in a 3 dimensional image of the vault initialized at vault sync with the CA. The vault launcher verifies application checksum (604). The vault launcher uses slot index to read a coin set into memory (606). There is an OTP for slot indices request online or on SMS from vault distributor (612) and user's pin accepted (614). The slot reader uses OTP to flip open coin (608). Device discoverer inquires nick name from multiple nearby devices (616). Then, user selects required nick name as revealed by a consumer (610). The device paired on mutually conveyed pass code (618). The devices exchange public keys (620). The sender encrypts coin using receivers public key and signs it using own private key. The coin is flipped. The coin and its signature are sending to consumer. The index of coin is marked as in transit (622). The consumer verifies signature and decrypts using the private key. The watermark) is verified using the certificates mentioned in URL collection. The sender can choose to make an online verification of coin and ownership of the coin (626). Then verify the coin and if coin verification success (624), then consumer flips coin using its private key and server's public key. Signs it using its private key. Send coin and signature to sender (628). Failure after acknowledgment is a commit (636) and failure before acknowledgment is rollback (638). The consumer requests change of ownership with community register in C4 as a proof provide signature of sender (630). The sender invokes slot writer to persist coin in slot and updates index with transferee id and signature (632) and sender have empty slot in next server sync (634).

The checksum verification process is described herein below:

The CA maintains a duplicate image of the vault content. This image is brought in congruence with the vault's content when a sync process triggers between the Vault and the C4. Every vault launch will allow multiple coin exchange transaction between member vaults in offline mode. However, launch of vault must necessarily trigger the application checksum verification with the CA. The verification process adopts the following method:

The vault and the CA designate a common coordinate in the 3D image representation of the vault. The coordinate shifts by one space in one of the 6 directions between each launcher verification. The coordinate is reinitialized on every vault to C4 Sync up.

The offset to this coordinate is used to pick up a byte stream as an input to a hashing algorithm. For a verification process, a dice is rolled in the vault by selecting any random number from 1 to 6. The number represents one of the values of the dice. The dice roll is meant for triggering the coordinate movement by one space in one of the six directions. A 1 means forward, 2 means reverse, 3 mean up, 4 means down, 5 means right and 6 means left. So the new coordinate will have one of its x, or y or z points changed by 1 or −1.

The byte stream digest of this offset is then used as an input for the OTP generator embedded in the vault. The application checksum is encrypted using this OTP and sent to CA for verification. The CA should affirm in its attempt to decrypt the checksum that the coordinate arrived at in the vault, is one of the expected movements into the image space due to the dice roll. The OTP at CA is generated for all possible 6 coordinates and once matched with the announced checksum from the vault, it agrees to proceed to the next phase of allowing a transaction in the vault. The C4 will now provide the vault with the slot reading key for enabling the coin reading and flipping for a transaction.

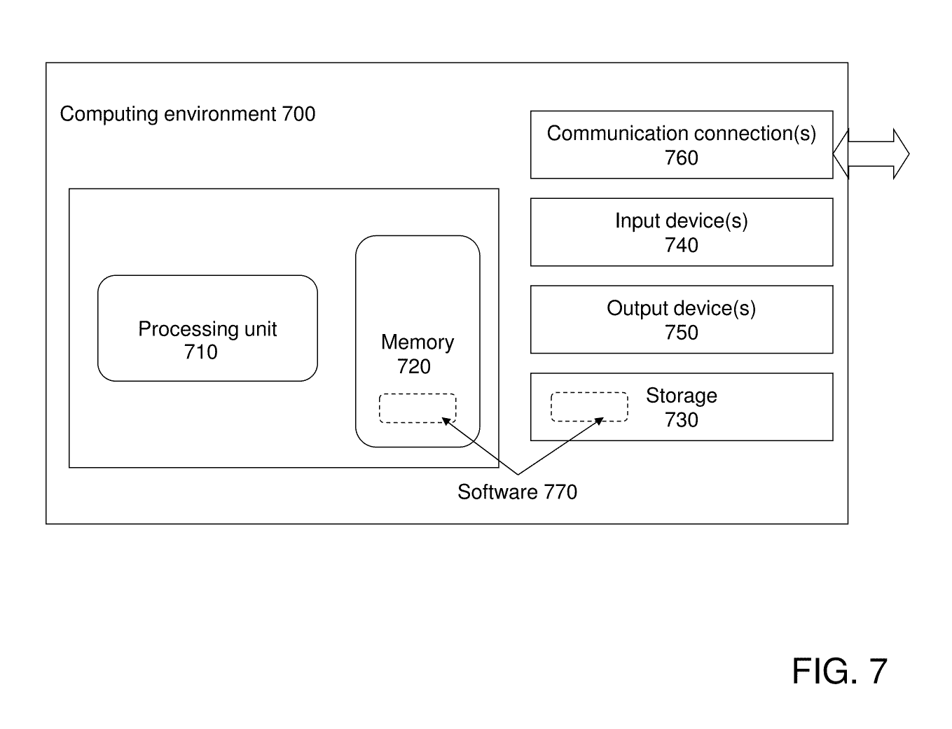

FIG. 7 shows a generalized computer network arrangement, in one embodiment of the present technique.

Exemplary Computing Environment

One or more of the above-described techniques may be implemented in or involve one or more computer systems. FIG. 7 shows a generalized example of a computing environment 700. The computing environment 700 is not intended to suggest any limitation as to scope of use or functionality of described embodiments.

With reference to FIG. 7, the computing environment 700 includes at least one processing unit 710 and memory 720. The processing unit 710 executes computer-executable instructions and may be a real or a virtual processor. In a multi-processing system, multiple processing units execute computer-executable instructions to increase processing power. The memory 720 may be volatile memory (e.g., registers, cache, RAM), non-volatile memory (e.g., ROM, EEPROM, flash memory, etc.), or some combination of the two. In some embodiments, the memory 720 stores software 770 implementing described techniques.

A computing environment may have additional features. For example, the computing environment 700 includes storage 730, one or more input devices 740, one or more output devices 750, and one or more communication connections 760. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The storage 730 may be removable or non-removable, and includes magnetic disks, magnetic tapes or cassettes, CD-ROMs, CD-RWs, DVDs, or any other medium which may be used to store information and which may be accessed within the computing environment 700. In some embodiments, the storage 730 stores instructions for the software 770.

The input device(s) 740 may be a touch input device such as a keyboard, mouse, pen, trackball, touch screen, or game controller, a voice input device, a scanning device, a digital camera, or another device that provides input to the computing environment 700. The output device(s) 750 may be a display, printer, speaker, or another device that provides output from the computing environment 700.

The communication connection(s) 760 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 700, computer-readable media include memory 720, storage 730, communication media, and combinations of any of the above.

In the present invention, the vault application can be operated in an online as well as in an offline mode. The user can choose a CA service or a peer Bluetooth vault service as per the need. The Bluetooth service will not require GPRS connectivity to operate. This means the airtime bandwidth requirement is reduced as well as cost of transaction is minimized with respect to network usage, since blue tooth is localized and free.

The present invention is applicable to secure electronic tokens which offer a wide space for innovative usage in commercial and social transactions. Since the tokens can be deemed to be valid, trustworthy, and verifiable and have time based existence, they can be used as promises of contracts and effective within a time period. The carrier of such tokens can claim rights on the promised obligation on presentment of it to an issuing authority. The issuing authority can thus regulate an open market for its instruments which can be exchanged in the market between participating parties for effecting the transactions in that market. This philosophy can create clusters of regulating authorities who can enable exchange of contracts and promises thereby creating new dimensions of social security. The regulating authority however, will need to create trust and respect around its operations such that the market it controls can be open and generally encompassing. As a downside, a collapse of the central authority can paralyze the market participants as the tokens circulating in the market are rendered useless.

The central agency can choose to distribute electronic tokens representing the country's currency in various denominations electronically. This will avoid the cost of currency printing or coins minting to the extent of electronic tokens in circulation. Additionally other complexities of cash disbursement and distribution are reduced. The entire process can be controlled through an automated system.

Currency duplication and faking is completely eliminated, creating a fair and just economy. Forceful and criminal extraction of wealth is eliminated from the holder of the electronic currency. Money traceability can enable and yet money anonymity can be achieved.

The electronic tokens can be used in insurance domain very effectively. A token holder of an insurance provider can lay claim on happening of an exigency by presenting the token for redemption. Since the token has time based value, auto expiration occurs after a designated period. This is useful for purchasing travel insurance, insurance for goods in transit etc. This can be used as a travelers check as well. The ‘coins’ and the vault combination can represent a temporary or permanent ‘pass’ to institutions regarding authorizing employees or guests into the premises.

The ‘coins’ can be associated with vaults on retailer's shelf such that a coin can be pulled from the shelf (when the vaults so allow) thereby representing an intention to buy the goods. The vault can then relay the coin dispensation to a central server, which can inform relevant delivery personal to package goods for the buyer and allow the buyer to collect the same from exit points after paying the price flashing on the mobile device and as calculated by the system in the delivery package. Thus the buyer gets the best of both worlds. A convenience of choosing goods by inspecting it, but buying it electronically and conveniently collecting it prepackaged at the exit points. From the retailers perspective it saves it of premium store space and handle deliveries in back office. This reduces operational costs dramatically. The vault can be customized for actions such are ‘return to shelf’, ‘pick how many’ etc.

Having described and illustrated the principles of our invention with reference to described embodiments, it will be recognized that the described embodiments may be modified in arrangement and detail without departing from such principles.

In view of the many possible embodiments to which the principles of our invention may be applied, we claim as our invention all such embodiments as may come within the scope and spirit of the claims and equivalents thereto.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The detailed description is presented to enable a person of ordinary skill in the art to make and use the invention and is provided in the context of the requirement for obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

1. A computer implemented method executed by one or more computing devices for providing a near field secure electronic token transaction, the method comprising the steps of:
generating at least one packet data structure, defined as a coin, by at least one generator;
storing said at least one coin in at least one mobile vault;
controlling said at least one coin through a coin distribution authority; and
transferring said coin to at least one consumer.

2. The method as claimed in claim 1, wherein a coin comprises a side one and a side two, wherein said side one is an open state of said coin and said side two is a closed state of said coin.

3-4. (canceled)

5. The method as claimed in claim 1, wherein a mobile vault comprises:
a slot set having a plurality of slots identified by a slot identifier;
a slot writer adapted to write at least one slot into a storage area;
a slot reader adapted to read a plurality of read operations;
a vault index;
a vault launcher adapted to verify application checksum and a pin entered by a user, and comparing a Bluetooth mac address with a real Bluetooth mac address.

6-8. (canceled)

9. The method of claim 1, wherein the at least one packet data structure comprises:
a coin id field of predetermined size comprising alphanumeric characters;
a coin value field comprising a plurality of attributes;
a coin content field;
a coin camouflage field comprising a plurality elements placed in a contiguous area of memory;
an attribute key field comprising a predetermined size of hexadecimal characters;
a URL collection field;
an issue date field, recording a date of creation of the coin;
an issuer field, wherein the issuer is a mint or a central agency;
an owner id field, wherein said owner id comprises a vault id;
an owner signature field, wherein said owner signature comprises a coin signature created by said owner's certificate;
first and second watermarks fields; and
a coin lock field.

10. (canceled)

11. The method of claim 9, wherein the first watermark field comprises a plurality of signatures of said plurality of elements of the coin camouflage field.

12. The method of claim 9, wherein the second watermark field comprises said first watermark field and the coin camouflage field.

13. The method of claim 1 further comprising:
connecting said vault holder with a coin dispenser of a central agency;
providing a dummy coin to said vault;
writing said coin by a vault writer to a slot;
maintaining a vault image in said central agency;
calculating a checksum of all objects specified in a random image;
sending said checksum to said coin dispenser by said vault;
verifying said image match by a validator in said central agency; and
disbursing said at least one coin to said vault if said vault image is matched.

14. The method of claim 1 further comprising:
receiving a request for a coin disbursement by a coin dispenser in a central agency;
providing at least one vault owner information to a coin store by said coin dispenser;
authorizing coin dissemination to said vault by said coin store;
checking for said coin availability by said coin store; and
requesting said mint for a coin creation if said coin is not available in said store,
wherein said requesting for said coin creation comprises:
assembling a first watermark and said coin camouflage by said mint; and
assembling a second watermark and a URL collection by said mint.

15. (canceled)

16. The method of claim 1, wherein the step of transferring said coin to at least one consumer comprises:
verifying an application checksum by a vault launcher;
sending said at least one coin to a consumer in an encrypted form by the vault;
verifying the encrypted coin by said consumer;
signing said encrypted coin with a private key by said consumer and sending said coin to said sender; and
requesting a change of a ownership with a community register in a central agency by said consumer.

17. A system for providing a near field secure electronic token transaction, the system comprising:
one or more processors; and
one or more memory units operatively coupled to at least one of the one or more processors and having instructions stored thereon that, when executed by at least one of the one or more processors, cause at least one of the one or more processors to:
generate at least one packet data structure, defined as a coin, by at least one generator;
store said at least one coin in at least one mobile vault;
control said at least one coin through a coin distribution authority; and
transfer said coin to at least one consumer.

18. The system of claim 17, wherein the coin comprises a side one and a side two, wherein said side one is an open state of said coin and said side two is a closed state of said coin.

19-20. (canceled)

21. The system of claim 17, wherein the mobile vault comprises:
a slot set having a plurality of slots identified by a slot identifier;
a slot writer adapted to write at least one slot into a storage area;
a slot reader adapted to read a plurality of read operations;
a vault index; and
a vault launcher adapted to verify application checksum and a pin entered by a user, and
comparing a Bluetooth mac address with a real Bluetooth mac address.

22-24. (canceled)

25. The system of claim 17, wherein the one or more memory store further instructions to cause the at least one of the one or more processors to:
connect said vault holder with a coin dispenser of a central agency;
provide a dummy coin to said vault;
write said coin by a vault writer to a slot;
maintain a vault image in said central agency;
calculate a checksum of all objects specified in a random image;
send said checksum to said coin dispenser by said vault;
verify said image match by a validator in said central agency; and
disburse said at least one coin to said vault if said vault image is matched.

26. The system of claim 17, the one or more memory store further instructions to cause the at least one of the one or more processors to:
receive a request for a coin disbursement by a coin dispenser in a central agency;
provide at least one vault owner information to a coin store by said coin dispenser;
authorize coin dissemination to said vault by said coin store;
check for said coin availability by said coin store; and
request said mint for a coin creation if said coin is not available in said store;
assemble a first watermark and said coin camouflage by said mint; and
assemble a second watermark and a URL collection by said mint.

27. (canceled)

28. The system of claim 17, the one or more memory store further instructions to cause the at least one of the one or more processors to:
verify an application checksum by a vault launcher;
send said at least one coin to a consumer in an encrypted form by the vault;
verify the encrypted coin by said consumer;
sign said encrypted coin with a private key by said consumer and sending said coin to said sender;
request a change of a ownership with a community register in a central agency by said consumer.

29. A non-transitory computer-readable medium having stored thereon instructions for providing a near field secure electronic token transaction, comprising machine executable code which when executed by at least one processor, causes the at least one processor to perform steps comprising:
generating at least one packet data structure, defined as a coin, by at least one generator;
storing said at least one coin in at least one mobile vault;
controlling said at least one coin through a coin distribution authority; and
transferring said coin to at least one consumer.

30-40. (canceled)

41. The system of claim 17, wherein the at least one packet data structure comprises:
a coin id field of predetermined size comprising alphanumeric characters;
a coin value field comprising a plurality of attributes;
a coin content field;
a coin camouflage field comprising a plurality elements placed in a contiguous area of memory;
an attribute key field comprising a predetermined size of hexadecimal characters;
a URL collection field;
an issue date field, recording a date of creation of the coin;
an issuer field, wherein the issuer is a mint or a central agency;
an owner id field, wherein said owner id comprises a vault id;
an owner signature field, wherein said owner signature comprises a coin signature created by said owner's certificate;
a first and a second watermark fields; and
a coin lock field.

42. The system of claim 41, wherein the first watermark field comprises a plurality of signatures of said plurality of elements of the coin camouflage field.

43. The system of claim 41, wherein the second watermark field comprises said first watermark field and the coin camouflage field.
